(19) United States
(12) Patent Application Publication
(10) Pub. No.: US 2004/0090473 A1
(43) Pub. Date: May 13, 2004

(54) Performance enhancement and upgrade attachment for a handheld computer

(76) Inventor: Bryan Scott, Plano, TX (US)

Correspondence Address: Steven Thrasher, 391 Sandhill Dr., Richardson, TX, 75080, US

(21) Appl. No.: 10/291,068

(22) Filed: Nov. 8, 2002

(51) Int. Cl. G09G 5/00

(52) U.S. Cl. 345/864; 345/738

(57) ABSTRACT

The invention provides systems, devices, and methods for upgrading the operating system of a personal digital assistant (PDA). One system according to the invention includes memory having a first operating system embedded therein, and a port coupled to the memory via a bus, the port enabled to connect to a PDA port. One method according to the invention upgrades an operating system in a personal digital assistant (PDA) by detecting a PDA attachment whereby a PDA having an operating system is detected at being attached to a port, initiating a start-up condition, overriding the operating system in the PDA, and initializing the PDA using a second operating system.

### TECHNICAL FIELD

The present invention relates to personal digital assistants, and more particularly the invention relates to attachments for personal digital assistants.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Users of handheld computers such as personal digital assistants (PDAs) almost universally agree that the PDA simplifies life by providing a common small, light-weight platform for maintaining contact information, calendars, and other data. More recently, PDAs have matured technologically to a level where they can support more advanced computing functions, such as word processing, database management, spreadsheet use, and audio/visual capabilities. These developments give PDAs the promise of eventually replacing desktop and laptop platforms. To realize these more advanced systems, and to stay on the cutting-edge of available PDA systems, one must purchase a new PDA. Accordingly, there is the need for devices, systems and methods for facilitating the upgrade a legacy handheld computers.

Additionally, methods to enhance the performance of PDAs do not exist. At best, current PDA device manufacturers provide a method to upgrade device software systems that requires the user to replace existing 3^{rd} party software applications and even re-enter lost data. Accordingly, there is the need for devices, systems, and methods for enhancing the performance of a current PDA system to also include increased memory, additional processing power, and additional input and output devices.

### SELECTED OVERVIEW OF SELECTED EMBODIMENTS

The present invention achieves technical advantages as systems, devices, and methods for upgrading a legacy handheld computer and enhancing the performance of a current handheld computer such as a personal digital assistant (PDA). One system according to the invention includes memory having a first operating system embedded therein, and a port coupled to the memory via a bus, the port enabled to connect to a PDA port. Another embodiment of the system, according to the invention includes memory having a first operating system embedded therein, a port coupled to the memory via a bus, a processor coupled to the bus, the port enabled to connect to a PDA. One method according to the invention upgrades a legacy handheld computer by replacing the legacy operating system in a PDA by detecting a PDA attachment whereby a PDA having an operating system is detected at being attached to a port, initiating a start-up condition, overriding the operating system in the PDA, and initializing the PDA using a second operating system native to the invention. Another method according to the invention enhances a current handheld computer by the operating system in the PDA working in parallel with the operating system in the invention whereby a PDA having an operating system is detected at being attached to a port, initiating a start-up condition, taking control of the operating system, and initializing the PDA using a second operating system native to the invention.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates one embodiment of an architecture of the invention;

FIG. 2 provides a method for upgrading a PDA OS;

FIG. 3 is a method for upgrading an operating system in a handheld personal computer; and

FIG. 4 is an alternative method for upgrading an operating system.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section.

Discussion of the Figures

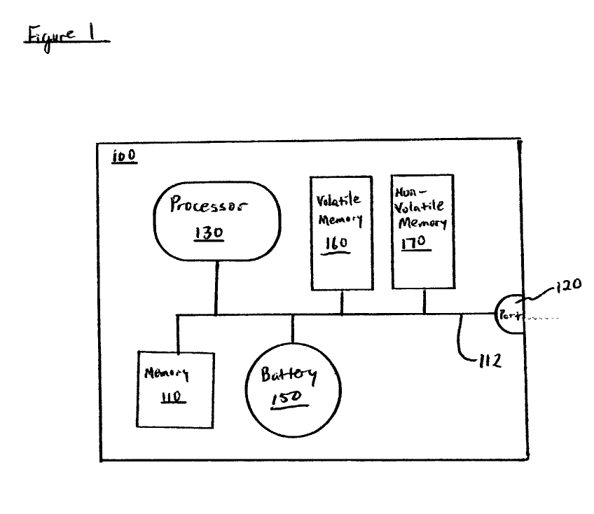

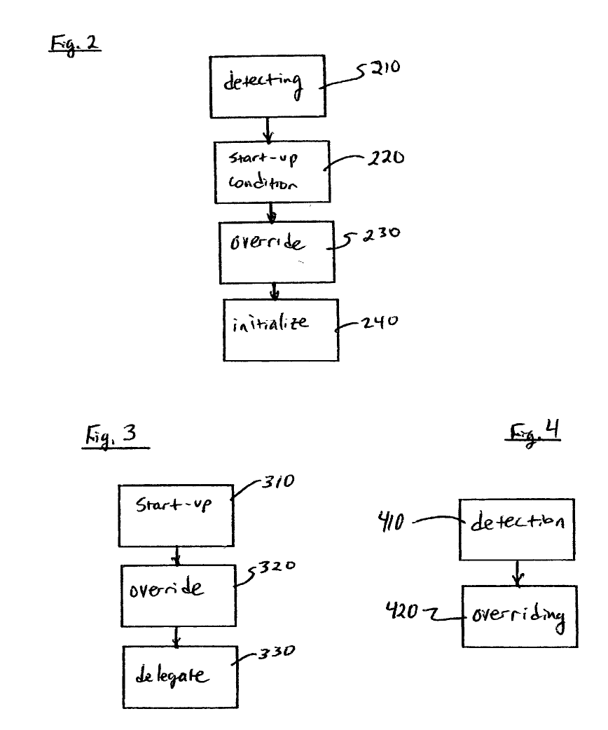

One embodiment of a system of the invention is an architecture that enables an external device, such as a compact-flash attachment or a PDA-attachment sleeve, for example. FIG. 1 illustrates one embodiment of an architecture of the invention, which is a system 100 for upgrading the operating system of a handheld computer, such as a personal digital assistant (PDA). The system 100 includes a memory 110 having a first operating system embedded therein. The system 100 couples to a port 120 via a bus 112. Preferably, the port 120 is enabled to connect to a handheld device port or slot, such as a compact flash slot or PCMCIA card slot, for example.

Of course, many additional functions and features may be provided to the invention by coupling a processor 130 to the bus 112. The processor is preferably a strong-arm processor, but any processor capable of running the new operating system maintained in the memory 110 is usable. In one embodiment, the processor 130 functions concurrently with a handheld computer-based processor, thus creating a coprocessor condition. When functioning as a coprocessor, the processor 130 preferably operates as a mater processor.

Additional functions can be provided to the invention when a memory upgrade is incorporated. Volatile memory, such as RAM, and/or non-volatile memory, such as ROM (or, preferably flash-enabled ROM) may be included in the invention. Each of volatile memory 160 or non-volatile memory 170 is preferably coupled to the bus 112.

To power the system, in one embodiment, a power line (not shown) runs from the bus 112 to the port 120, thus enabling any system component to receive power by tapping into a power-line on the bus 112 (the port 120 receives power from a power-line running from a handheld computer via a power-enabled port, as is known in the art. In an alternative embodiment, additional power is provided to the system via an on-board power supply, such as a battery 150. In yet another embodiment, the additional power source is able to receive power (for operation or for recharging) via a handheld computer.

In another embodiment, the invention is practiced as a method. FIG. 2 provides a method for upgrading a PDA OS. In general, the method of upgrades an operating system in a personal digital assistant (PDA) by detecting a PDA attachment whereby a PDA having an operating system is detected at being attached to a port 210, and then initiating a start-up condition 220. Next, the invention overrides the operating system in the handheld computer 230 and initializes the handheld computer using a second operating system 240.

Alternatively, the method upgrades an operating system in a handheld personal computer such as a personal digital assistant (PDA) by initiating a start-up condition in the handheld computer 310, receiving an override command from a secondary device such that the operating system onboard the handheld computer is interrupted 320, and then delegating the operating system to a secondary device 330. In yet another alternative embodiment, the invention upgrades an operating system in a handheld computer such as a personal digital assistant (PDA) by detecting a handheld computer attachment whereby a handheld computer having an operating system is detected at being attached to a port 410, and then overriding the operating system in the handheld computer such that the operating system in the handheld computer is inoperable so long as the handheld computer is attached 420.

Though the invention has been described with respect to a specific preferred embodiment, many variations and modifications will become apparent to those skilled in the art upon reading the present application—such as the application of the invention to the cutting of animal hair/fur. It is therefore the intention that the appended claims be interpreted as broadly as possible in view of the prior art to include all such variations and modifications.

What is claimed is:

1. A system for upgrading the operating system of a handheld computer, comprising:
memory having a first operating system embedded therein;
a port coupled to the memory via a bus, the port enabled to connect to a handheld computer port.

2. The system of claim 1 further comprising a processor coupled to the bus.

3. The system of claim 1 further comprising volatile memory coupled to the bus.

4. The system of claim 1 further comprising non-volatile memory coupled to the bus.

5. The system of claim 1 further comprising a power source coupled to at least the memory.

6. The system of claim 2 wherein the processor functions as a master co-processor.

7. The system of claim 3 wherein the volatile memory is random access memory.

8. The system of claim 4 wherein the non-volatile memory is flash-enabled read-only memory.

9. The system of claim 1 wherein the port is adapted to couple power from a handheld computer to the bus.

10. The system of claim 1 wherein the handheld computer is a personal digital assistant (PDA).

11. The system of claim 1 wherein the handheld computer is a smartphone.

12. A method of upgrading an operating system in a handheld computer, comprising:
detecting a handheld computer attachment whereby a handheld computer having an operating system is detected at being attached to a port;
initiating a start-up condition;
overriding the operating system in the handheld computer; and
initializing the handheld computer using a second operating system.

13. The method of claim 12 wherein the handheld computer is a personal digital assistant.

14. A method of upgrading an operating system in a handheld computer, comprising:
initiating a start-up condition in the handheld computer;
receiving an override command from a secondary device such that the operating system onboard the handheld computer is interrupted; and
delegating the operating system to a secondary device.

15. The method of claim 14 wherein the handheld computer is a personal digital assistant.

16. A method of upgrading an operating system in a handheld computer, comprising:
detecting a handheld computer attachment whereby a handheld computer having an operating system is detected at being attached to a port;
overriding the operating system in the handheld computer such that the operating system in the handheld computer is inoperable so long as the handheld computer is attached.

17. The method of claim 16 wherein the handheld computer is a personal digital assistant.
